(19) United States
(12) Patent Application Publication
(10) Pub. No.: US 2004/0016816 A1
(43) Pub. Date: Jan. 29, 2004

(54) Thermostatic valve for sanitary fixtures

(76) Inventors: Gerhard Ginter, Tennenbronn (DE); Andreas Ginter, Schramber-Heiligenbronn (DE); Franz Wanner, Neufried (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/204,930

(22) PCT Filed: Feb. 10, 2001
(86) PCT No.: PCT/EP01/01489

(30) Foreign Application Priority Data
Feb. 12, 2000 (DE) 10006374.8

(51) Int. Cl. G05D 23/13

(52) U.S. Cl. 236/12.15

(57) ABSTRACT

A thermostatic valve for sanitary fittings contains an extensible material element, which is exposed to the temperature of the mixed water resulting from the mixing of hot and cold water. The extensible material element is operatively connected to two closing bodies each associated with a valve and which move simultaneously when the mixed water temperature changes.

The hot and cold water enter the mixing space where the extensible material element is located in opposite directions, whereas the mixed water flows out of the mixing chamber at a point positioned between both inlet valves.

In the sanitary sector so-called thermostatic valves are known, i.e. valves in which the once set mixed water temperature is regulated by the valve. Such sanitary fittings have one operating element in order to adjust the quantity of the outflowing mixed water, as well as another operating element for adjusting the desired temperature of the mixed water.

Thermostatic valves are conventionally constructed in such a way that they contain an extensible material element exposed to the mixed water temperature and which in the case of a change to said temperature moves a closing body, which simultaneously serves for two inlet valves. The inlet opening for the cold water and the inlet opening for the hot water are constructed as narrow slots extending along a circumference and a cylindrical annular area serves as the closing body. Said annular body must be sealed to the outside. During its axial movement for modifying the cross-section of both inlet openings, the seal is moved over a surface. The water flowing through the inlet openings must flow out of the mixing area axially, so that the flows of both inlet openings pass in the same direction. The closing element must be a ring through which the water flows. An example of such a thermostat is given in DE 19716307 A1.

The problem of the invention is to improve the operation of a thermostatic valve for sanitary fittings.

To solve this problem the invention proposes a thermostatic valve having the features of claim 1. Further developments of the invention form the subject matter of the dependent claims, whose wording, like that of the abstract, is by reference made into part of the content of the description.

As opposed to the prior art, in the case of the thermostatic valve according to the invention the outlet is positioned so as to be located between the two inlet valves. As a result there is an equalization of the temperature through an improved mixing of the hot and cold water. The invention also makes it possible to economize the closing body seal, which is subject to wear.

The expansion element exposed to the mixed water temperature can advantageously be a mechanically operating element, e.g. a bimetallic element or an extensible material element conventionally used in such thermostats.

The outlet from the area into which the hot and cold water flow for mixing together, can in particular be positioned centrally between the inlet valve for the cold water and the inlet valve for the hot water.

Whereas in the prior art the valve seat is a narrow torus in a sleeve, the invention proposes that the valve seat of at least one of the two valves and preferably both valves is formed by a substantially planar torus, which is advantageously bounded by an opening formed by the edge of the valve seat and through which the water flows into the mixing space or area.

It can in particular be provided that the tori of both valves are located in mutually parallel planes, which according to a further development of the invention can form the end faces of the mixing space. The simultaneous movement of the two closing bodies can consequently be an axial movement in the mixing space. The closing bodies can have a disk-like construction.

According to a further development of the invention the expansion elements forms a single component with the closing bodies of both valve seats. This can e.g. be implemented in such a way that the closing elements for both valve seats are part of the expansion element or form part of such an expansion element.

According to a further development of the invention, the water through both valves passes in opposite directions into the mixing space. This leads to a particularly effective mixing of the water flow and therefore to the obtaining of a uniform mixing temperature to which the expansion element can then be exposed.

Further features, details and advantages of the invention can be gathered from the following description of a preferred embodiment of the invention with reference to the attached drawings, wherein show:

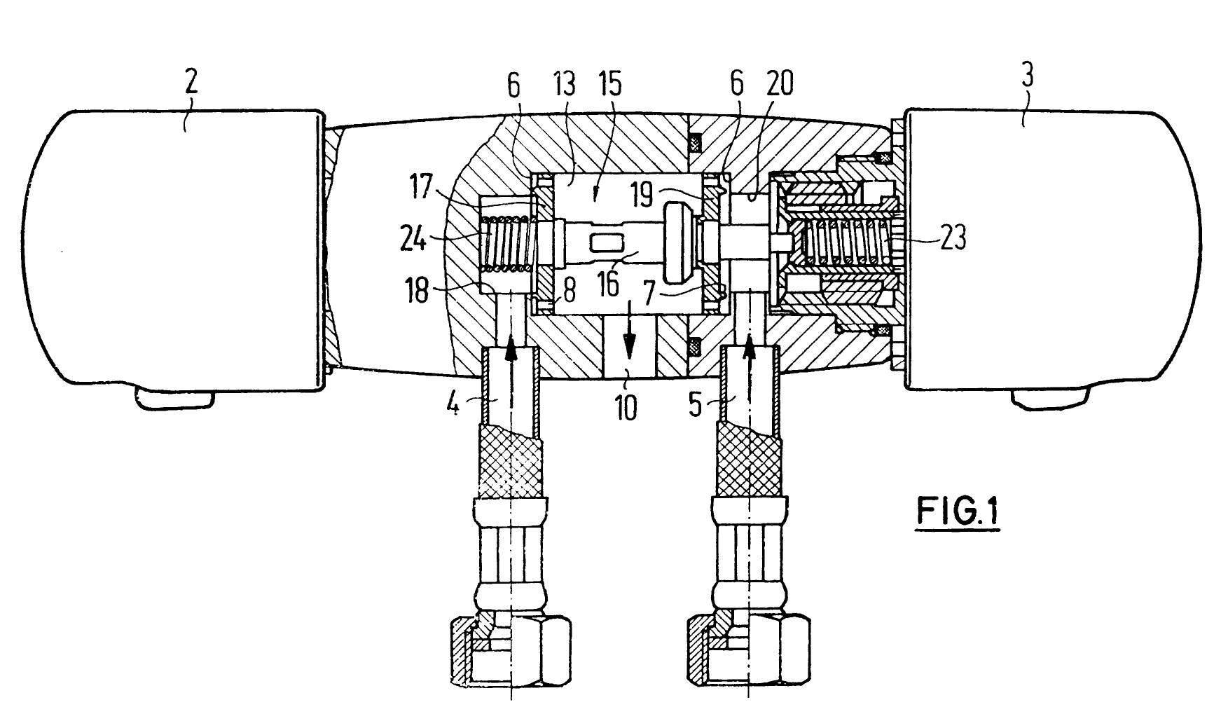

FIG. 1 A longitudinal section through a thermostatic valve according to the invention.

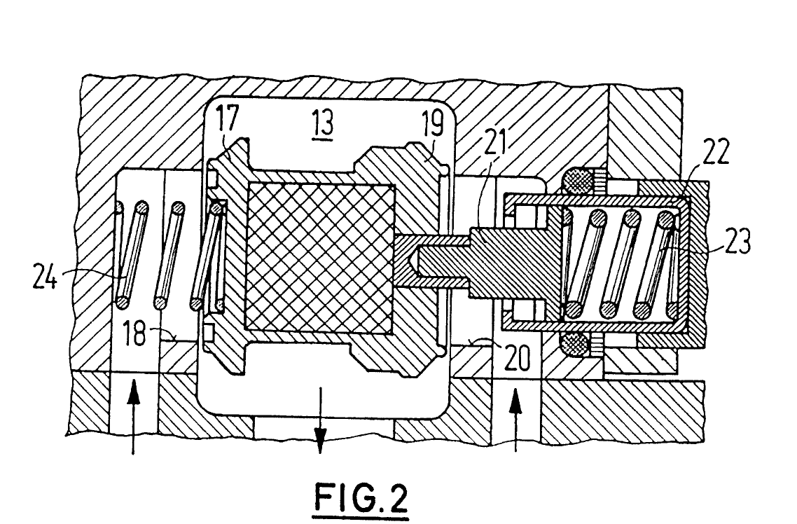

FIG. 2 On a larger scale compared with FIG. 1, a diagrammatic representation of the operation of the thermostatic valve.

FIG. 1 is a part sectional view of a thermostatic valve according to the invention. The thermostatic valve contains a fitting body 1, which has an elongated and slightly convex shape. In the vicinity of its one end is provided a grip 2 for regulating the quantity of the mixed water leaving the thermostatic valve. It can be turned about the longitudinal axis of the valve. At the opposite end is provided a handle 3 enabling the desired temperature of the mixed water to be adjusted.

Into the fitting body 1 leads radially a hot water intake 4 and a cold water intake 5. The two intakes, which can e.g. be constituted by hoses, issue into radial bores, which in each case issue in a cylindrical space 18, 20 within the fitting body 1.

Roughly centrally in the fitting body 1 is formed a cylindrical space 13, which is coaxial to the said body and serves to receive a valve. The cylindrical space 18 into which the hot water intake leads, issues in the form of a circular, coaxial opening into the central mixing space 13. Thus, the opening is surrounded by a shoulder face 6.

On the opposite front face of the mixed water space 13 issues as a concentric opening of the cylindrical space 20 into which leads the cold water intake 5.

A valve element with a regulating unit 15 is inserted in the space 13. The regulating unit 15 contains an extensible material element, which responds and reacts to temperature changes. In the vicinity of its one axial end, the regulating unit contains a closing element 17 connected therewith and which in the embodiment shown is constituted by a flat disk. On its side facing the front face of the chamber 13 the closing element 17 contains a circumferential, concentric bead, which cooperates with the shoulder 6 surround the opening 18. Together with the shoulder 6, the closing element 17 forms a valve. The marginal area of the shoulder 6 surrounding the opening 18 consequently forms a valve seat.

In the vicinity of its opposite, axial end the regulating unit 15 contains a second closing element 19 having a similar construction and connected thereto, which has its bead 7 on the side facing the space 20. Said closing element 19 is also constructed as a flat disk. The bead 7 cooperates with the shoulder 6 surrounding the opening 20. Here again a valve with its valve seat is formed.

The mutual spacing of the two closing elements 17, 19 is chosen in such a way that the axial spacing of the outside of the beads 7 is smaller than the spacing between the shoulders 6. Thus, one of the two valves is always open. Radially outside the bead 7, both closing elements 17, 19 contain axially directed openings or holes 8. The closing elements 17, 19 extend up to the jacket of the cylindrical space 13 and consequently guide the regulating unit 15.

When the valve for the hot or cold water is open, the water flows through the gap between the shoulder 6 and the crest of the bead 7 to the outside and then through the openings or holes 8 into the space 13. From space 13 an outlet opening 10 leads to a not shown outlet from the fitting.

In the expansion element 16 is located a material expanding when the temperature is raised. If the material in the interior of the expansion element 16 expands, there is a displacement thereof to the left in the drawings together with the two closing elements 17, 19 and this takes place counter to the action of a control spring 24. During this displacement there is a reduction in the flow cross-section of the valve formed by the openings 18 and the closing body 17. Simultaneously on the opposite side there is an increase in the spacing between the closing body 19 and the edge of the opening 20. In this way the ratio of the flow cross-section of the hot water to the flow cross-section of the cold water is modified.

As is indicated by the arrows, both flows flow through the openings 18, 20 into the space 13, where mixing takes place. This space is referred to here as the mixing space. The expansion element 16 is exposed to the temperature of the mixed water in said space. It consequently regulates the opening cross-sections of the two valves as a function of the mixed water temperature.

The outlet from said space in the direction of the downwardly pointing arrow in FIGS. 1 and 2 takes place at a point, which is spatially, and in the movement direction of the closing body, between the two valves. The two flows pass in oppositely directed manner into the mixing space 13, so that they very rapidly and adequately mix there. Thus, the expansion element 16 relatively rapidly assumes the mixed water temperature.

By adjusting the bias of the control spring 23, as a result of a change in the axial position of the outer tappet 22, it is possible to adjust the position of the closing elements 17, 19 and therefore the desired temperature of the thermostatic valve. As both water passages leading to the inlet valves are separate from one another, no seal is required for the closing elements 17, 19.

FIG. 2 diagrammatically shows on a larger scale a second embodiment, where once again the expansion element 16 is located between the two inlet valves, considered in the direction of movement. In this embodiment the expansion element is constructed as a single component, which in the vicinity of its one axial end forms the closing element 17 and in the vicinity of its opposite end forms the closing element 19. The two closing elements are so constructed and dimensioned that in the radial direction they do not lead to the edge of the inner space 13 in which the water is mixed. The hot and cold water consequently flow past the closing elements 17, 19 when the valve is open.

In the interior of the expansion element is formed a space filled by the material responding to temperature changes. At the front faces the wall thickness of the expansion element is much greater than on the jacket, so that the mixed water present in the space 13 in the interior mainly determines the expansion of the element.

If the material in the interior of the expansion element expands, it acts on a tappet 21, which ebgages in a second tappet 22 and is telescopically mounted opposite the same. The compression spring 23 forming an overload spring is here positioned between the inner front face of the outer tappet 22 and the outer front face of the inner tappet 21.

By modifying the position of the outer tappet 22, e.g. with the aid of the handle 3 shown in FIG. 1, the bias of the spring 24 and therefore the desired temperature of the thermostatic valve can be modified. The operation of the valve shown in FIG. 2 corresponds to that shown in FIG. 1, so that there is no need for a further detailed description thereof.

1. Thermostatic valve for sanitary fittings, having
1.1 an inlet valve for cold water leading into a mixing space (13),
1.2 an inlet valve for hot water leading into the mixing space (13),
1.3 which in each case have a valve seat and a closing element (17, 19),
1.4 an expansion element (16) located in the mixing space (13) and exposed to the mixed water temperature and which
1.4.1 is operatively connected with both closing elements (17, 19) and
1.4.2 jointly moves the same for controlling both valves in the case of temperature changes, as well as with
1.5 an outlet for the mixed water, which
1.5.1 is positioned between both valves.

2. Thermostatic valve according to claim 1, wherein the valve seat of at least one of the two valves is formed by a substantially planar torus.

3. Thermostatic valve according to claim 1 or 2, wherein the valve seat of both valves is formed by a substantially planar torus.

4. Thermostatic valve according to one of the preceding claims, wherein the planes, in which the valve seats of both valves are located, are parallel to one another.

5. Thermostatic valve according to one of the preceding claims, wherein the planes, in which the valve seats of both valves are located, form the front faces of the mixing space (13).

6. Thermostatic valve according to one of the preceding claims, wherein the expansion element (16) forms a single component with the closing elements (17, 19) of both valves.

7. Thermostatic valve according to one of the preceding claims, wherein the closing elements (17, 19) of both valves form part of the extensible material element (16).

8. Thermostatic valve according to one of the preceding claims, wherein the water is guided through the two valves in opposition and preferably passes axially into the mixing space (13) and is in particular removed radially therefrom.

9. Thermostatic valve according to one of the preceding claims, wherein the expansion element contains an extensible material element.

10. Thermostatic valve according to one of the claims 1 to 8, wherein the expansion element (16) has a bimetallic element.

11. Thermostatic valve according to one of the claims 1 to 8, wherein the expansion element has a memory metal element.
